(19) United States
(12) Patent Application Publication
(10) Pub. No.: US 2013/0104104 A1
(43) Pub. Date: Apr. 25, 2013

(54) SYSTEM AND METHOD FOR REFACTORING A BLOCK OF SOFTWARE

(71) Applicants: Prakriya Venkata Ramana Murthy, Bangalore (IN); Tushar Sharma, Bangalore (IN)

(72) Inventors: Prakriya Venkata Ramana Murthy, Bangalore (IN); Tushar Sharma, Bangalore (IN)

(21) Appl. No.: 13/699,058

(22) PCT Filed: Mar. 7, 2011
(86) PCT No.: PCT/EP2011/053361

§ 371 Date: Jan. 9, 2013

(30) Foreign Application Priority Data
May 21, 2010 (IN) 559/KOL/2010

(51) Int. Cl. G06F 9/44

(52) U.S. Cl. CPC G06F 8/72
USPC 717/120

(57) ABSTRACT

A system for refactoring a block of software may include an analyzer for receiving a set of workflows via a user interface and configured to analyze each of the workflows one at a time to determine a set of refactoring opportunity, the user interface configured to transfer the set of workflows from a user to the analyzer and to transfer a set of refactoring opportunity from the analyzer to said user after said analysis of said set of workflows. The system also includes set of refactoring opportunity into a step-wise arrangement of implementation of said set of refactoring opportunity on said block of software, an implementation device for implementing said set of refactoring opportunity on said block of software to produce a refactored block of software and over a design associated to said block of software to produce a refactored design associated to said refactored block of software.

### CROSS-REFERENCE TO RELATED APPLICATIONS

This application is a U.S. National Stage Application of International Application No. PCT/EP2011/053361 filed Mar. 7, 2011, which designates the United States of America, and claims priority to IN Patent Application No. 559/KOL/2010 filed May 21, 2010. The contents of which are hereby incorporated by reference in their entirety.

### TECHNICAL FIELD

The present disclosure relates to refactoring a block of software. More specifically, the present disclosure relates to refactoring said block of software on a basis of refactoring opportunities identified from workflows in said block of software.

### BACKGROUND

Software development is an iterative process where said block of software is changed periodically to add new features as per the requirements of a software user or changes are made in reference to fix a bug while software testing process. Continuous feature additions and bug fixing, introduces various anti-patterns in said block of software and the design associated to said block of software. To maintain the software, said block of software needs to be refactored at regular intervals, otherwise maintenance of said block of software becomes tedious, time consuming and error prone.

To refactor software having huge number of codes is difficult due to manual comprehensibility of such software. It becomes even more difficult to refactor if area of implementation of software like healthcare, industry, automation, security, etc. is unknown to a software developer or user.

One way of refactoring is suggested in the document: M. Fowler, “Refactoring: Improving the Design of Existing Programs”, Addison-Wesley, 1999. It suggests various code level and design level refactoring techniques. Code level refactorings requires just local (file/class level) knowledge and may be performed with little knowledge of overall software and less effort but, design level refactorings requires relatively better understanding of software and are harder to achieve.

### SUMMARY

In one embodiment, a system for refactoring a block of software may comprise: an analyzer adapted to receive a set of workflows via a user interface and adapted to analyze each of the workflows to determine a set of refactoring opportunity, the user interface adapted to transfer the set of workflows from a user to the analyzer and to transfer a set of refactoring opportunity from the analyzer to said user after said analysis of said set of workflows.

In a further embodiment, the system further comprises an integrator adapted to integrate said set of refactoring opportunity into a step-wise arrangement of implementation of said set of refactoring opportunity on said block of software.

In a further embodiment, the integrator is adapted to integrate said set of refactoring opportunity by resolving a design conflict between design decisions proposed by said set of refactoring opportunity for a design associated to said block of software. In a further embodiment, the system further comprises an implementation device adapted to implement said set of refactoring opportunity on said block of software to produce a refactored block of software. In a further embodiment, the implementation device is adapted to implement said set refactoring opportunity over said design associated to said block of software to produce a refactored design associated to said refactored block of software. In a further embodiment, the system further comprises a testing device including a test case, said testing device adapted to verify functionality of said refactored block of software on a basis of result obtained by executing said refactored block of software on said test case. In a further embodiment, the system is adapted to update a document related to said block of software on a basis of a result obtained from refactoring of said block of software.

In another embodiment, a method to refactor a block of software comprises transferring a set of workflows from a user to an analyzer via a user interface, analyzing said set of workflows to determine a set of refactoring opportunity, and transferring said set of refactoring opportunity from said analyzer to said user via said user interface.

In a further embodiment, the method further comprises integrating said set of refactoring opportunity into a step-wise arrangement of implementation of said set of refactoring opportunity on said block of software. In a further embodiment, the method further comprises integrating said set of refactoring opportunity by resolving a design conflict between design decisions proposed by said set of refactoring opportunity for a design associated to said block of software. In a further embodiment, the method further comprises implementing said set of refactoring opportunity by an implementation device over said block of software to produce a refactored block of software. In a further embodiment, the method further comprises implementing said set of refactoring opportunity by said implementation device over said design associated to said block of software to produce a refactored design associated to said refactored block of software. In a further embodiment, the method further comprises testing said refactored block of software by a testing device to verify functionality of said refactored block of software on a basis of result obtained by executing said refactored block of software on a test case. In a further embodiment, the method further comprises updating a document related to said block of software on a basis of a result obtained from refactoring of said block of software.

### BRIEF DESCRIPTION OF THE DRAWINGS

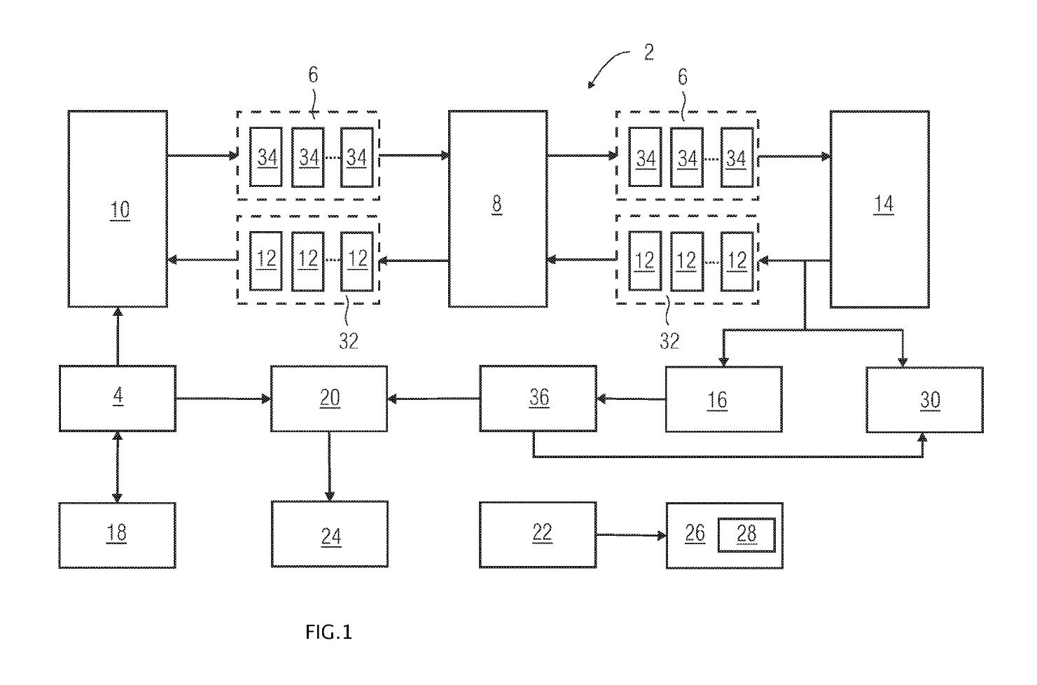

An example embodiment will be explained in more detail below with reference to FIG. 1, which illustrates a schematic diagram of the system refactoring a block of software to produce refactored block of software.

### DETAILED DESCRIPTION

Some embodiments provide systems and methods to refactor a block of software systematically such that said block of software is maintainable by a software developer easily and in a timesaving way.

According to an embodiment, a system for refactoring a block of software includes an analyzer and an user interface, wherein the analyzer is adapted to receive a set of workflow via the user interface and adapted to analyze each of the workflows to determine a set of refactoring opportunit, and the user interface is adapted to receive the set of workflows from a user and adapted to transfer said set of workflows from the user to the analyzer and to transfer said set of refactoring opportunity from said analyzer to said user. Such a system makes it easy to determine the refactoring opportunity for a software developer, as the workflows are analyzed by the system itself.

According to one embodiment, the system has an integrator adapted to integrate said set of refactoring opportunity into a step-wise arrangement of implementation of said refactoring opportunity on said block of software, so that said refactoring opportunity can be implemented one by one in an step-wise order to remove any possibility of haphazard and unstructured refactoring of said block of software.

According to yet another embodiment, the integrator is further adapted to integrate said set of refactoring opportunity by resolving a design conflict between design decisions proposed by said set of refactoring opportunities for a design associated to said block of software. Such a system helps to remove design conflicts also while refactoring said block of software.

According to one embodiment, the system includes an implementation device adapted to implement said set of refactoring opportunity on said block of software to produce a refactored block of software. Such system makes it easy to refactor the block of software, as the refactoring is done automatically.

According to another embodiment, the implementation device is adapted to implement said refactoring opportunity over the design associated to the block of the software to produce a refactored design associated to said refactored block of software. Such a system implements said set of refactoring opportunity over both, said block of software and as well as said design for said block of software, so as to produce said refactored design associated to said refactored block of software along with said refactored block of software.

According to yet another embodiment, the system further includes a testing device including a test case, said testing device is adapted to verify functionality of said refactored block of software on a basis of result obtained by executing said refactored block of software on said test case. This helps to test the refactored block of software before being used by the software user.

FIG. 1 illustrates an embodiment that includes an analyzer 14 receiving a set of workflows 6 via a user interface 8 and analyzing each of the workflow 6 one at a time to determine a set of refactoring opportunity 32, the user interface 8 for transferring the set of workflows 6 from a user 10 to the analyzer 14 and a set of refactoring opportunities from the analyzer 14 to the user 10, an integrator 16 for integrating said set of refactoring opportunity 32 into the step-wise arrangement 36 of implementation of said set of refactoring opportunity 32 on said block of software 4, an implementation device 20 for implementing said set of refactoring opportunity 32 over said block of software 4 to produce a refactored block of software 22 and over a design 36 of said block of software 4 to produce refactored design 24 for said refactored block of software 22.

A workflow 34 refers to a use-case and finer level steps involved in the use-case. In addition, the workflow 34 has information about the classes and/or methods that realize the steps in the use case. The workflow 34 also has information that belongs to various levels of abstraction. For example, a workflow for loading an image specifies a use-case for providing an image id and load image into specific container, steps involved in loading image from database, process image, validate image and display image, and classes and/or methods that correspond to the above steps in the use case for providing and loading the image.

These workflows 34 are sent to the analyzer 14 in the set 6, wherein the workflows 34 can occur simultaneously as well consecutively at a same time. Before being sent to the analyzer 14 for analysis, the set of workflows 6 are identified from the block of the software. The workflows can either be identified by the software user 10 or a workflow identifying device from the block of software 4. The workflow identifying device can be any specific or general purpose processor having ability to identify workflows from the block of software 4. The workflows are identified on a basis of requirements for refactoring said block of software 4. Theses requirements refers to factors like, new features addition to said block of software 4, flaws in the block of software 4 identified by a testing team, synchronization requirements of various parts of said block of software 4 or integration of said block of software 4 to any machine or any other such requirements. In furtherance, the workflows 34 are prioritized and provided to the analyzer 14 in the set of workflows 6. In spite of being provided as the set 6, the workflows 34 can also be provided to the analyzer 14 one at a time on the basis of the prioritization. The priority is determined on factors, such that to reduce difficulty of maintaining/changing a workflow, criticality of a workflow, etc.

The analyzer 14 receives the set of workflows 6 via a user interface 8 and analyzes each of the workflows 6 one at a time to determine said set of refactoring opportunity 32. The analyzer 14 analyzes the set of workflows 6 on the basis of prioritization of the said workflows 6. Alternatively, the analyzer 14 can analyze workflows 6 simultaneously or a combination of simultaneous and one at a time pattern or any other pattern, method or algorithm so that analysis of said workflow 6 would result in said set of refactoring opportunity 32. The analyzer 14 analyzes said workflows 6 in a way, so that analyzing each workflow 6 produces a refactoring opportunity or a group of refactoring opportunity. The analyzer 14 combines all the refactoring opportunity into a set of refactoring opportunity 32 to be provided to the user 10 via the user interface 8. In an alternate embodiment, the analyzer 14 also removes any overlapping of refactoring opportunity or any contingency between any two refactoring opportunity in the set of refactoring opportunity. Yet alternatively, the analyzer 14 only analyzes workflow to produce refactoring opportunity and each of the refactoring opportunity can be sent to the integrator 16 one by one as soon each of the refactoring opportunity is produced, while the integrator 16 can combine all the refactoring

The set of refactoring opportunity 32 includes a plurality of refactoring opportunities 12 determined on a basis of the workflow 34 or a combination of the workflows 34 out of the set of the workflows 6. The set of refactoring opportunity 12 can be arranged in a particular fashion or can be arranged haphazardly on the basis of analysis done by analyzer.

The integrator 16 integrates the set of refactoring opportunities 12 into the step-wise arrangement 36 of implementation of said refactoring opportunity on said block of software 4. So that, the block of software 4 can be refactored in a step-wise fashion by implementing the refactoring opportunities on the block of software 4 as per the step-wise arrangement 36 of the refactoring opportunities.

While integration, the integrator 16 further resolves a design conflict between design decisions proposed by said set of refactoring opportunity 12 associated to a design 18 for said block of software 4. In an alternate embodiment, said design conflicts need not be removed by said system 2 rather said system 2 only integrates said refactoring opportunities 12 into a set of refactoring opportunity 34. Yet alternatively, the software user 10, whether machine or human, can integrate said set of refactoring opportunity 12 into a step-wise arrangement 36 of implementation of said set of refactoring opportunity on said block of software 4. In yet another embodiment, the software user 10 can also remove the design conflicts between design decisions proposed by said set of refactoring opportunity for the design 18 associated to said block of software.

The implementation device 20 implements said set of refactoring opportunity 34 on said block of software 4 to produce a refactored block of software 22. On the basis of said set of refactoring opportunity 34, said implementation device 20 makes changes in said block of software 4 in a chronological order or step-wise fashion, applying each refactoring opportunity 12 at a time to produce said refactored block of software 22. The set of refactoring opportunity 34 need not be applied one by one rather it can be simultaneous to various components of said block of software 4 simultaneously or in a combination of steps of one by one or simultaneous. The fashion for implementing the said set of refactoring opportunity 34 can be based on any available algorithm, method or pattern which can optimally implement said set of refactoring opportunity 34 on said block of software 4 to produce said refactored block of software 22 in a way to reduce time and resource consumption during refactoring said block of software 4. Alternatively, said refactored block of software 22 can be generated manually by changing the code through changes in class and/or method, or through abstraction or by using any other structured or non-structured approach.

The implementation device 20 also implements said set of refactoring opportunity 34 over said design 18 for the block of software 4 produces a refactored design 24 for said refactored block of software 22. Alternatively, said refactored design 24 for said refactored block of software 22 can be generated separately by said software developer 10 manually or automatically using another device.

The testing device 26 verifies functionality of said refactored block of software 22 on a basis of result obtained by executing said refactored block of software 22 on a test case 28 included in said testing device 26. The testing device 26 tests said refactored block of software 22 by testing functionality and non-functionality or static and dynamic behavior of said refactored block of software 22. The testing device 26 use testing techniques like black box testing, white box testing or grey box testing to test said refactored block of software 22. The testing device 26 tests functionality of said refactored block of software 22 at various levels by executing said refactored block of software 22 through either unit testing, integration testing, system testing, system integration testing, regression testing, acceptance testing, alpha testing, beta testing or any such testing which tests various components of said refactored block of software 22 for verifying functionality of said refactored block of software 22 within the components, with said components and said software user 10, or any other such testing at the functional level. The testing device 26 also verifies functionality of said refactored design 24 on a basis of result obtained by executing said refactored design 24 on said test case 28. Alternatively, said refactored design 24 for said refactored block of software 22 can be tested separately by said software developer 10 manually or automatically using another device.

The system 2 updates a document 30 related to said block of software 4 on a basis of a result obtained from refactoring of said block of software 4. The document 30 can be related to development of said block of software 4 or the document 30 can be related to structure of codes of said block of software 4 or formulations or representations of said design 18 for said block of software 4 or any other process related documents for development of said block of software 4 or a manual for said software user 10 or any other such document in relation to said block of software 4 which can be helpful for said software user 10 for adding or deleting any substantial part to said block of software 4 or testing said block of software 4.

In one embodiment, functions of the analyzer 14, or the integrator 16, or the implementation device 20, or the testing device 26 or combination thereof can be performed by one processor or any general purpose processor like personal computer, etc. enabled to perform the above-said functions.

What is claimed is:

1. A system for refactoring a block of software comprising:
an analyzer comprising logic instructions stored in non-transitory computer-readable media and executable to:
receive a set of workflows via a user interface, and
analyze each of the workflows to determine a set of refactoring opportunity, and
wherein the user interface comprises logic instructions stored in non-transitory computer-readable media and executable to:
transfer the set of workflows from a user to the analyzer, and
transfer a set of refactoring opportunity from the analyzer to said user after said analysis of said set of workflows.

2. The system according to claim 1, further comprising:
an integrator comprising logic instructions stored in non-transitory computer-readable media and executable to integrate said set of refactoring opportunity into a step-wise arrangement of implementation of said set of refactoring opportunity on said block of software.

3. The system according to claim 2, wherein the integrator is configured to integrate said set of refactoring opportunity by resolving a design conflict between design decisions proposed by said set of refactoring opportunity for a design associated to said block of software.

4. The system according to claim 2, further comprising:
an implementation device comprising logic instructions stored in non-transitory computer-readable media and executable to implement said set of refactoring opportunity on said block of software to produce a refactored block of software.

5. The system according to claim 4, wherein the implementation device is configured to implement said set refactoring opportunity over said design associated to said block of software to produce a refactored design associated to said refactored block of software.

6. The system according to claim 5, further comprising:
a testing device including a test case and comprising logic instructions stored in non-transitory computer-readable media and executable to verify functionality of said refactored block of software on a basis of result obtained by executing said refactored block of software on said test case.

7. The system according to claim 1, wherein the system is configured to update a document related to said block of software on a basis of a result obtained from refactoring of said block of software.

8. A method for refactoring a block of software, comprising:
transferring a set of workflows from a user to an analyzer via a user interface,
analyzing said set of workflows to determine a set of refactoring opportunity, and
transferring said set of refactoring opportunity from said analyzer to said user via said user interface.

9. The method according to claim 8, further comprising:
integrating said set of refactoring opportunity into a step-wise arrangement of implementation of said set of refactoring opportunity on said block of software.

10. The method according to claim 9, further comprising:
integrating said set of refactoring opportunity by resolving a design conflict between design decisions proposed by said set of refactoring opportunity for a design associated to said block of software.

11. The method according to further comprising:
implementing said set of refactoring opportunity by an implementation device over said block of software to produce a refactored block of software.

12. The method according to claim 11, further comprising:
implementing said set of refactoring opportunity by said implementation device over said designer associated to said block of software to produce a refactored design associated to said refactored block of software.

13. A method according to further comprising:
testing said refactored block of software by a testing device to verify functionality of said refactored block of software on a basis of result obtained by executing said refactored block of software on a test case.

14. The method according to further comprising:
updating a document related to said block of software on a basis of a result obtained from refactoring of said block of software.
